(19) United States
(12) Patent Application Publication
(10) Pub. No.: US 2009/0273119 A1
(43) Pub. Date: Nov. 5, 2009

(54) Imprint Method and Imprint Apparatus

(76) Inventor: Tetsuya Imai, Saitama (JP)

Correspondence Address: WENDEROTH, LIND & PONACK, L.L.P., 1030 15th Street, N.W.,, Suite 400 East, Washington, DC, 20005-1503, US

(21) Appl. No.: 12/224,955

(22) PCT Filed: Feb. 26, 2007
(86) PCT No.: PCT/JP2007/053517

§ 371 Date: Jan. 15, 2009

(30) Foreign Application Priority Data
Mar. 10, 2006 (JP) 2006-066734

(51) Int. Cl. B29C 59/02

(52) U.S. Cl. 264/293; 425/385

(57) ABSTRACT

[Problems] In an imprint method, any displacement of a pattern shape due to thermal deformation of a mold is prevented and the pattern shape is formed accurately on a substrate.

[Solving Means] The present invention provides an imprint method for pressing a mold 3 having a pattern formed on a surface thereof against a transfer layer 1a on a substrate 1 to replicate the shape of the pattern of the mold 3 to the transfer layer 1a. A peripheral portion of the surface of the mold 3 is held by a retaining component 5 onto a mold holding component 4, and in this state, the mold 3 is pressed against the transfer layer 1a on the substrate 1.

### TECHNICAL FIELD

The present invention relates to an imprint method and an imprint apparatus.

### BACKGROUND ART

An imprint technique has received attention as a method of fabricating nano-level microstructures at a low cost and is expected to be applied to microfabrication of devices including magnetic disks, semiconductor devices, lasers, and optical waveguides, and microfabricated components including MEMS (Micro Electro Mechanical Systems) and NEMS (Nano Electro Mechanical Systems).

As semiconductor devices are increasingly reduced in size, a photolithography technique suffers from an increased cost of associated apparatuses since a high-resolution photomask is required by using laser light of short wavelength in an exposure apparatus. Thus, the imprint technique is desirably used to achieve low-cost patterning.

In the imprint technique, a mold having a fine pattern formed thereon and a substrate having a transfer layer formed on its surface through application of a transfer material thereto are individually heated to a softening point of the transfer layer or higher, and then the mold is brought into contact with the transfer layer on the substrate and is pressurized to deform the transfer layer into the shape of the pattern. With the application of the pressure maintained, the mold and the substrate are cooled to harden the transfer layer and then the mold is released from the transfer layer. In this manner, the fine pattern of the mold can be transferred to the transfer layer to provide the substrate having the fine pattern formed thereon.

Patent Document 1 describes a transfer apparatus which attempts to apply pressure uniformly to a master and a substrate and to release the master from the substrate easily after transfer by providing an elastic body placed around the master and the substrate between a master holder and a substrate holder. The elastic body can relieve stress concentration onto the master and the substrate at the pressing and produce stress in the releasing direction from the so-called wedge effect of the elastic body at the releasing.

[Patent Document 1] Japanese Patent No. 3638513

### DISCLOSURE OF THE INVENTION

### Problems to be Solved by the Invention

The conventional imprint technique, however, employs a fine pattern formed on a mold, so that thermal expansion and contraction of the mold due to temperature changes during the process causes a displacement of the mold from the substrate to make it impossible to accurately replicate the pattern shape. Since the substrate and the mold are cooled during the hardening of the transfer layer on the substrate with the transfer layer on the substrate kept in contact with the mold, thermal contraction of the mold may damage the surface of the transfer layer and the hardened transfer layer may damage the mold. In addition, the heating of the mold to the softening point of the transfer layer or higher thermally expands the mold, so that accurate positioning of the mold at the proper place is prevented in the upstream step in which the transfer layer on the substrate is brought into contact with the mold.

In the method described in Patent Document 1, the master is simply held under vacuum on the master holder, and if the master holder insecurely holds the master, the master may be partially deformed due to thermal deformation thereof to cause faulty transfer or to damage the master and the master holder. On the other hand, if the master holder securely holds the master, the thermal deformation amount of the master may be limited to produce thermal stress within the master, thereby damaging the master.

Since the method described in Patent Document 1 includes the heating after the master is held under vacuum on the master holder, the master is thermally deformed with its entire back side held on the holder, which results in large thermal stress.

The abovementioned problems are examples which the present invention attempts to solve. It is thus an object of the present invention to provide an imprint method and an imprint apparatus which can prevent a displacement of a pattern shape due to thermal deformation of a mold to accurately form the pattern shape on a substrate.

### Means for Solving Problems

As described in claim 1, the present invention provides an imprint method for pressing a mold having a pattern formed on a surface thereof against a transfer layer on a substrate to replicate the shape of the pattern of the mold to the transfer layer, including pressing the mold against the transfer layer on the substrate in a state in which a peripheral portion of the surface of the mold is held by a retaining component pressurized by a substrate holding component for holding the substrate.

As described in claim 10, the present invention provides an imprint apparatus for pressing a mold having a pattern formed on a surface thereof against a transfer layer on a substrate to replicate the shape of the pattern of the mold to the transfer layer, including a substrate holding component which holds the substrate, a mold holding component which holds the mold, and a retaining component which is pressurized by a portion of the substrate holding component outside a substrate holding position to retain a peripheral portion of the surface of the mold.

### BRIEF DESCRIPTION OF DRAWINGS

FIG. 1 A schematic diagram showing an imprint apparatus of Embodiment 1 according to the present invention.

FIG. 2 A diagram for explaining the dimensions of the imprint apparatus shown in FIG. 1.

FIGS. 3(a) to 3(d) Front views showing exemplary retaining components of the imprint apparatus shown in FIG. 1.

FIG. 4 A schematic diagram for explaining an example of attachment of the retaining component in the imprint apparatus shown in FIG. 1.

FIGS. 5(a) to 5(e) Diagrams for explaining imprint steps in the imprint apparatus shown in FIG. 1.

FIG. 6 A flowchart for the imprint steps in the imprint apparatus shown in FIG. 1.

FIG. 7 A schematic diagram showing an imprint apparatus of Embodiment 2 according to the prevent invention in cross section.

FIG. 8 A schematic diagram showing an imprint apparatus of Embodiment 3 according to the prevent invention in cross section.

FIG. 9 A schematic diagram showing an imprint apparatus of Embodiment 4 according to the prevent invention in cross section.

FIG. 10 A schematic diagram showing an imprint apparatus of Embodiment 5 according to the prevent invention in cross section.

FIG. 11 A schematic diagram showing an imprint apparatus of a modification of Embodiment 5 according to the prevent invention in cross section.

FIG. 12 A diagram showing an example of a pattern for a magnetic disk.

FIGS. 13(a) to 13(e) Diagrams for explaining steps of fabricating a magnetic disk.

FIGS. 14(f) to 14(l) Diagrams for explaining steps of fabricating the magnetic disk.

FIG. 15 A flow chart showing steps of fabricating the magnetic disk.

### DESCRIPTION OF REFERENCE NUMERALS

1 SUBSTRATE
1A TRANSFER LAYER
2 SUBSTRATE HOLDING COMPONENT
3 MOLD
4 MOLD HOLDING COMPONENT
4A VACUUM ABSORPTION PORTION
5 RETAINING COMPONENT
5A RIGID PART
5B ELASTIC PART
6 TEMPERATURE ADJUSTING APPARATUS
6A, 6B HEATER
7 DRIVING APPARATUS
8 POSITION ADJUSTING APPARATUS
9 CONTROL APPARATUS
10 GUIDE MEMBER
11 AIR BLOW MECHANISM
12 ELASTIC SUPPORT MEMBER
21 SURVO PATTERN PORTION
22 PATTERNED DATA TRACK PORTION
105 BASE SUBSTRATE
106 TRANSFER MATERIAL
107 HARD MASK LAYER
108 STACKED RECORDING FILM LAYER
110 RECORDING FILM LAYER
111 NON-MAGNETIC MATERIAL
112 LUBRICATING LAYER
113 PROTECTING LAYER

### BEST MODE FOR CARRYING OUT THE INVENTION

Preferred embodiments according to the present invention will hereinafter be described with reference to the accompanying drawings. The present invention is not limited to the illustration in the following description.

### Embodiment 1

Embodiment 1 will be described with reference to FIGS. 1 to 6.

FIG. 1 is a schematic diagram showing an imprint apparatus of Embodiment 1 in cross section.

The imprint apparatus shown in FIG. 1 includes a substrate holding component 2 for holding a substrate 1 having a transfer layer 1a formed thereon, a mold holding component 4 for holding a mold 3 having a pattern formed thereon, a retaining component 5 for retaining a peripheral portion of a surface of the mold 3, a temperature adjusting apparatus 6 for adjusting the temperatures of the substrate 1 and the mold 3, a driving apparatus 7 for driving the substrate holding component 2 toward or away from the mold holding component 4 (in a vertical direction in FIG. 1), a position adjusting apparatus 8 for adjusting the relative positions of the substrate holding component 2 and the mold holding component 4, and a control apparatus 9 for controlling these apparatuses.

The substrate 1 can be a Si (silicon) substrate, a glass substrate or the like in a flat shape and can be formed of silicon wafer, quartz substrate, aluminum substrate, or provided by placing a semiconductor layer, a magnetic layer, or a ferroelectric layer on the abovementioned substrate. The transfer layer 1a is formed on the substrate 1 by applying a transfer material thereto through spin coating or the like. The transfer layer 1a on the substrate 1 can be made of resin material or any other material to which the pattern shape of the mold 3 can be transferred, and for example, metal and glass can be used. If the substrate 1 is made of material to which the pattern shape of the mold 3 can be transferred such as resin film, bulk resin, and glass having a low melting point, then the upper layer portion of the substrate 1 can be handled as the transfer layer 1a, and the pattern shape of the mold 3 can be directly transferred to the substrate 1 without applying any transfer material thereto.

When the transfer layer 1a is made of thermoplastic resin such as acrylic, the substrate 1 and the mold 3 are heated to the softening point of the thermoplastic resin or higher and the transfer layer 1a on the substrate 1 is pressed against the mold 3 in that heating state to deform the transfer layer 1a on the substrate 1 in accordance with the pattern shape of the mold 3. With the pressing of the transfer layer 1a on the substrate 1 against the mold 3 maintained, the substrate 1 and the mold 3 are cooled to harden the transfer layer 1a. The cooling refers to lowering of the temperature to the level at which the resin constituting the transfer layer 1a is hardened, and includes not only cooling performed on purpose with a cooling means but also lowering of the temperature through self-cooling and lowering of the temperature while heating with a heating means is continued. The pattern shape on the surface of the transfer layer 1a is determined in this manner. Then, the mold 3 is released from the transfer layer 1a on the substrate 1, with the result that the transfer layer 1a on the substrate 1 has the pattern shape of the mold 3 transferred thereto. During the process, the mold 3 undergoes thermal deformation due to the temperature changes from the temperature equal to or higher than the softening point to the hardening point of the transfer layer 1a.

The softening point corresponds to a glass transition temperature (Tg) for a polymeric material. For a crystalline polymer, however, softening may not occur at a temperature higher than Tg and the softening point may be close to the melting temperature of the crystal. The softening point also corresponds to a thermal deformation temperature (Td) defined as a temperature at which a material under a certain load is deformed to a certain degree.

When the transfer layer 1a is made of photo-curing resin, the transfer layer 1a on the substrate is pressed against the mold 3, and after the transfer layer 1a on the substrate is formed into the pattern shape of the mold 3, ultraviolet rays are applied to harden the transfer layer 1a. In this case, it is not necessary to perform a heating process for softening the transfer layer 1a. However, the mold 3 is subjected to the heat generated in the hardening of the transfer layer 1a to undergo some changes in temperature before the mold 3 is released from the transfer layer 1a on the substrate 1, thereby causing thermal deformation of the mold 3.

The substrate holding component 2 has a flat substrate-holding surface and holds the substrate 1 by attaching the substrate 1 to the substrate holding surface, for example, through vacuum absorption, electrostatic absorption, or mechanical clamping. The substrate holding component 2 includes a marginal portion outside the position for holding the substrate 1. The retaining component 5, later described, is placed on the marginal portion.

The substrate holding component 2 contains a heater 6a as a means for uniformly heating the substrate holding surface. The heater 6a is controlled by the temperature adjusting apparatus 6 to achieve adjustment of the temperatures of the substrate 1 and the transfer layer 1a. The temperature adjusting apparatus 6 adjusts the heating temperature of the heater 6a such that the substrate 1 is heated to the softening point of the transfer layer 1a or higher before the transfer layer 1a on the substrate 1 is brought into contact with the mold 3.

The substrate holding component 2 is driven by the driving apparatus 7 toward and away from the mold holding component 4 (in the vertical direction in FIG. 1) to perform operation for pressing the transfer layer 1a on the substrate 1 against the mold 3 and releasing the transfer layer 1a from the mold 3. With the transfer layer 1a on the substrate 1 kept in contact with the mold 3, the substrate holding component 2 is further pressurized toward the holding component 4 to press the transfer layer 1a on the substrate against the surface of the mold 3 having the pattern formed thereon. While the substrate holding component 2 is driven in Embodiment 1, the present invention is not limited thereto. The substrate holding component 2 may be fixed and the mold holding component 4 may be driven, or both of the substrate holding component 2 and the mold holding component 4 may be driven relatively.

The position of the substrate holding component 2 is adjusted by the position adjusting apparatus 8 such that the relative positions of the substrate 1 and the mold 3 are adjusted. The position adjusting apparatus 8 horizontally moves the substrate holding component 2 relative to the mold holding component 4 to adjust their positions in order to achieve the adjustment of the position of the substrate 1 on the substrate holding component 2 and the position of the surface of the mold 3 having the pattern formed thereon on the mold holding component 4. It is also possible to correct a horizontal displacement of the substrate holding component 2 from the mold holding component 4 in order to press the transfer layer 1a on the substrate against the mold 3 in parallel. The position adjusting apparatus 8 may be provided for the mold holding component 4.

The temperature adjusting apparatus 6, the driving apparatus 7, and the position adjusting apparatus 8 are controlled by the control apparatus 9.

The mold 3 has on its surface the fine pattern of asperities which is to be transferred to the transfer layer 1a and is made of Si (silicon), glass, an alloy of Ni (nickel) or the like. The surface of the mold having the fine pattern of asperities formed thereon is subjected to surface treatment with a silane coupling agent or the like for the purpose of preventing adhesion of the transfer material or the like used in the transfer layer 1a and facilitating the releasing. The mold 3 is formed to be larger than the substrate 1. When the transfer layer 1a on the substrate 1 is pressed against the mold 3, the peripheral portion of the surface of the mold 3 is not covered with the substrate 1 (exposed).

The mold holding component 4 includes a flat mold-holding surface for holding the mold 3 and a vacuum absorption portion 4a at the center of the mold holding surface. When the mold 3 is placed on the mold holding surface of the mold holding component 4, the vacuum absorption portion 4a holds the mold 3 by fixing the mold 3 at the central portion on the back thereof. The present invention is not limited to the vacuum absorption and the mold 3 may be held with electrostatic absorption. The mold 3 held by the mold holding component 4 is fixed and held only at the central portion and is not fixed in the peripheral portion. Even when the mold 3 is expanded or contracted due to thermal deformation, the mold 3 is slid on the mold holding component 4 from the center toward the outside and thus uneven deformation of the mold 3 is avoided to prevent distortion of the mold surface.

The mold holding component 4 contains a heater 6b as a heating means similar to the heater 6a contained in the substrate holding component 2 described above. The heating operation of the heater 6b is controlled by the temperature adjusting apparatus 6 to achieve adjustment of the temperature of the mold 3. Alternatively, the temperature adjustment may be performed only in the mold holding component 4, and in the substrate holding component 2, the heat transferred from the mold 3 may soften the transfer layer 1a. Alternatively, the temperature adjustment may be performed for the whole unit including the substrate holding component 2 and the mold holding component 4.

The mold holding component 4 is installed at a fixed position. The substrate holding component 2 is moved in the vertical direction in FIG. 1 as described above to bring the transfer layer 1a on the substrate 1 closer to the mold 3, to press the transfer layer 1a against the mold 3, or to release the transfer layer 1 from the mold 3.

The retaining component 5 is placed outside the substrate holding position of the substrate holding component 2 at the position opposed to the peripheral portion on the surface of the mold 3 held by the mold holding component 4. The retaining component 5 has a thickness larger than the combined thickness of the transfer layer 1a and the substrate 1 held by the substrate holding component 2. As the substrate holding component 2 approaches the mold holding component 4, the retaining component 5 is brought into contact with the mold 3 prior to contact of the transfer layer 1a on the substrate 1 to press the peripheral portion of the mold 3 against the mold holding component 4. This fixedly sets the position of the peripheral portion of the mold 3 to the mold holding component 4 to prevent expansion and contraction due to thermal deformation of the mold 3.

The retaining component 5 is formed by placing an elastic part 5b on a rigid part 5a such that the rigid part 5a is placed closer to the mold 3 and the elastic part 5b is placed closer to the substrate holding component 2. The rigid part 5a has a thickness smaller than the combined thickness of the substrate 1 and the transfer layer 1a, and the combined thickness of the rigid part 5a and the elastic part 5b is larger than the combined thickness of the substrate 1 and the transfer layer 1a. When the substrate holding component 2 causes the retaining component 5 to press the surface of the mold 3, the elastic part 5b is contracted to reduce the thickness of the whole retaining component 5 to approximately the combined thickness of the substrate 1 and the transfer layer 1a. At this point, the retaining component 5 is pressed against the mold 3 to such an extent that expansion and contraction of the mold 3 due to thermal deformation is prevented.

In this manner, the retaining component 5 is formed of the elastic part 5b placed on the rigid part 5a, and the retaining component 5 is contracted as a whole in the direction in which the transfer layer 1a on the substrate is pressed against the mold 3. This allows the retaining component 5 to press the peripheral portion of the mold 3 by using the pressure applied by the substrate holding component 2 to push the transfer layer 1a on the substrate 1 against the mold 3.

Since the retaining component 5 is in contact with the mold 3 through the surface of the rigid part 5a, it can retain the mold 3 securely with the surface having a high coefficient of friction.

The rigid part 5a is processed to have the flat surface similar to the surface of the mold in order to retain the peripheral portion of the mold 3 over the surface. The rigid part 5a is preferably made of material having resistance to repeated temperature changes and strength to applied pressures, and for example, SUS (stainless), Ti (titanium), and an alloy thereof can be used.

The elastic part 5b included in the retaining component 5 allows the pressing of the peripheral portion of the mold 3 with uniform pressure even when the mold 3 is uneven in thickness or is distorted.

The elastic part 5b can be formed of elastic film or sheet made of rubber such as silicone rubber and resin, or mechanical spring such as coil spring, not shown.

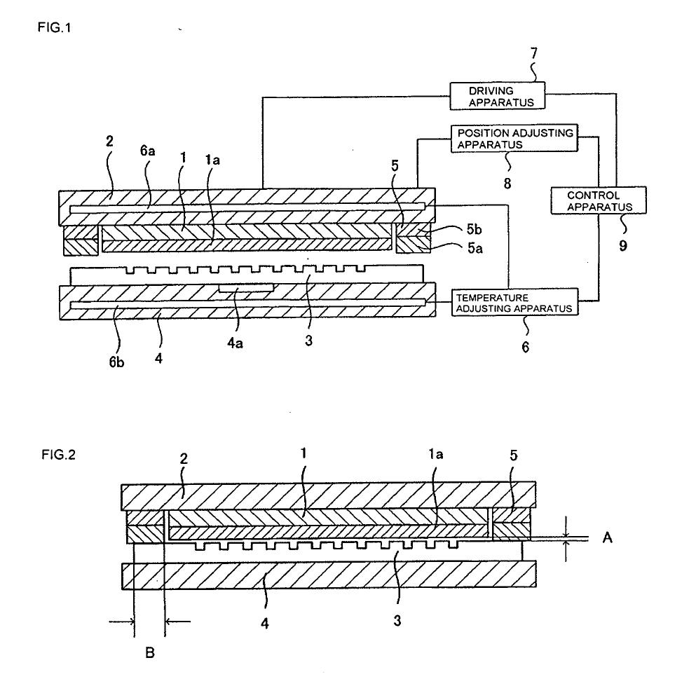

As shown in FIG. 2, an interval A between the mold 3 and the transfer layer 1 is preferably 0.1 mm or more when the retaining component 5 is in contact with the mold 3. In other words, the difference between the combined thickness of the substrate 1 and the transfer layer 1a and the thickness of the retaining component 5 is preferably 0.1 mm or more.

The width of the peripheral portion of the mold 3 that is held by the retaining component 5 is preferably one-tenth of the width of the substrate 1 (defined as the length of one side of the substrate or corresponding to the diameter when the substrate has a circular shape). In the section view of FIG. 2, since the two retaining components of the same size are provided oppositely on the left and right in the peripheral portion. When the width of the peripheral portion of the mold 3 that is held by the left retaining component 5 in FIG. 2 is defined as B, the width of the peripheral portion that is held by the left or right retaining component 5 is preferably one-fifth which is half of one-tenth. Thus, the width B in FIG. 2 can be determined from the following expression. The width may be adjusted outside the range depending on the size of the surface of the substrate 1 having the pattern formed thereon or the like.

length of B≧((length of one side of substrate 1)/10/2

For an item having a diameter of 120 mm such as an optical disk to which transfer is performed, by way of example, the following is given:

(120 mm/10)/2=6 mm

and the size of the mold 3 and the width of the retaining component 5 may be determined so as to provide the width of 6 mm or more for the peripheral portion of the mold 3 that is held by the retaining component 5.

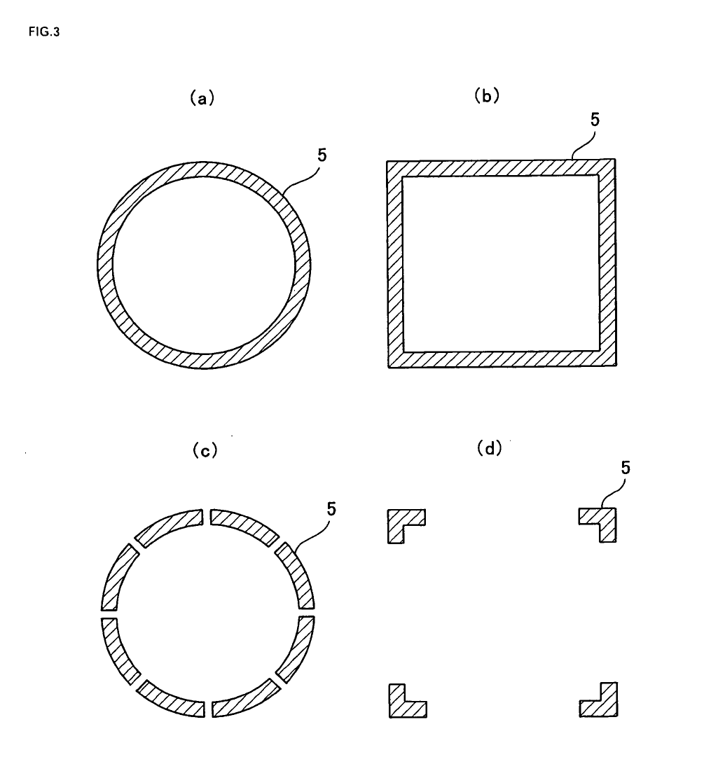

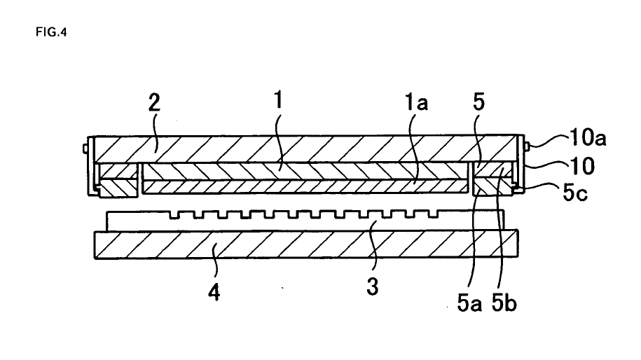

FIGS. 3(a) to 3(d) shows front views of the retaining component 5. The retaining component 5 is preferably provided over the entire peripheral portion of the mold 3 in accordance with the shape of the mold 3. The retaining component 5 has a circular shape for the circular mold 3 as shown in FIG. 3(a) and has a square shape for the square mold 3 as shown in FIG. 3(b). For the circular mold 3, the retaining component may have a partially missing circular shape as shown in FIG. 3(c). For the square mold 3, the retaining component 5 may have a shape which covers at least four corners of the mold 3.

The retaining component 5 is directly fixed to the substrate holding component 2 with bolts or is mounted through a guide member fixed to the substrate holding component 2. For example, as shown in FIG. 4, the retaining component 5 is mounted by providing a protruding portion 5c on the outer surface of the rigid part 5a of the retaining component 5, fixing a clip-shaped guide member 10 to the outer surface of the substrate holding component 2 with a bolt 10a or the like, and hooking the other end of the guide member 2 on the protruding portion 5c of the retaining component 5. The guide member 10 holds the retaining component 5 not to interfere with deformation of the elastic part 5b of the retaining component 5.

Next, an imprint method with the abovementioned imprint apparatus will be described. The following example is described in conjunction with thermal imprint in which the transfer layer 1a is made of thermoplastic resin and hardened through cooling.

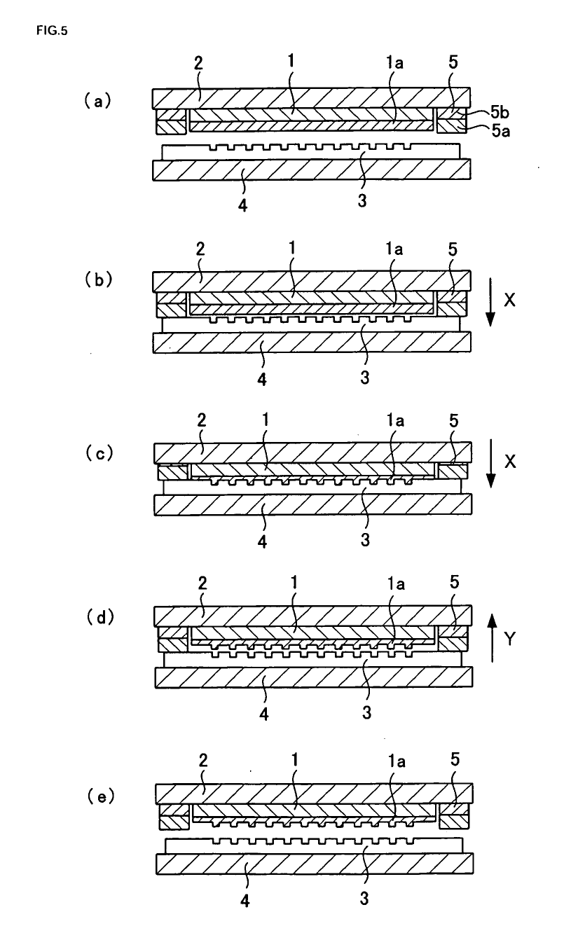

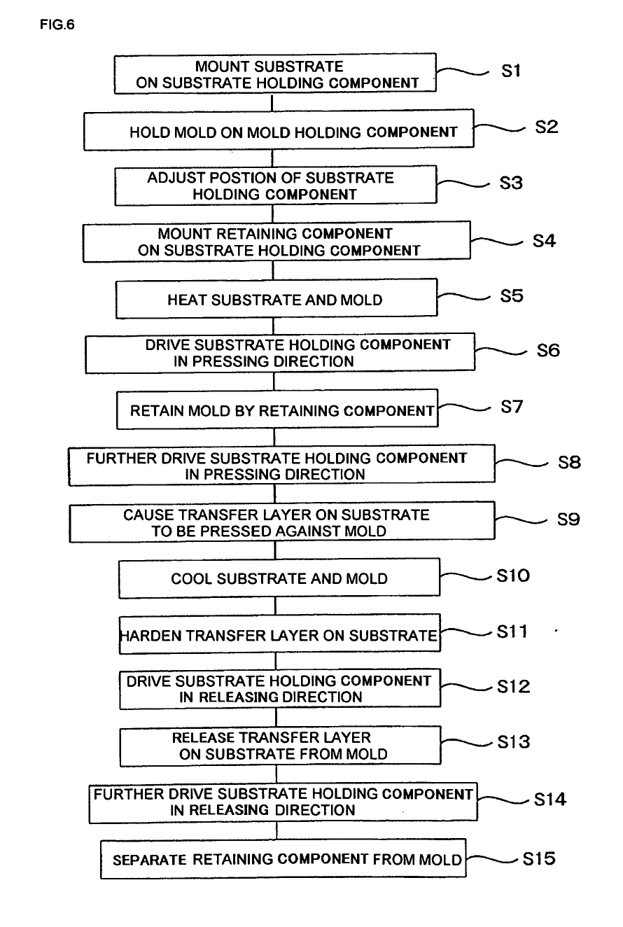

FIGS. 5(a) to 5(e) are diagrams for schematically explaining the imprint method. FIG. 6 is a flow chart illustrating the imprint method. In FIG. 6, each step is described with an associated reference numeral.

At step S1, as shown in FIG. 5(a), the substrate 1 having the transfer layer 1a formed on the surface is mounted on the substrate holding surface of the substrate holding component 2 with the central portion positioned. At this point, the portion of the substrate holding component 2 outside the substrate holding position is reserved for mounting of the retaining component 5 thereon.

At step S2, the mold 3 having the pattern formed thereon is placed on the mold holding surface of the mold holding component 4 with the central portion positioned. The mold 3 is fixed and held at the central portion on the back by the vacuum absorption portion 4a.

At step S3, the relative positions of the substrate 1 and the mold 3 are adjusted by the position adjusting apparatus 8. Alternatively, the position adjustment may be performed after the retaining component 5 is mounted at the next step S4.

Next, at step S4, the retaining component 5 is mounted to place the elastic part 5b outside the substrate holding position of the substrate holding component 2. The placement position is adjusted such that the rigid part 5a of the retaining component 5 is opposed to the peripheral portion of the mold 3 held by the mold holding component 4. The retaining component 5 may not be mounted each time processing is performed. For example, the retaining component 5 may be replaced when the type of the substrate or the lot is changed, but otherwise the retaining component 5 may be mounted continuously on the substrate holding component 2.

Next, at step S5, the substrate 1 and the mold 3 are heated to the temperature at which the transfer layer 1a is softened or higher by adjusting the temperature rises of the heaters 6a and 6b of the substrate holding component 2 and the mold holding component 4, respectively, with the temperature adjusting apparatus 6.

The mold 3 is expanded due to thermal deformation from the heating at this point. Since the mold 3 is fixed and held only at the central portion on the back, it is expanded and slid outward from the center on the mold holding surface. This prevents uneven distortion of the mold 3 to keep the mold surface flat.

At step S6, as shown in FIG. 5(b), after the mold 3 is sufficiently heated and its thermal expansion is finished, the substrate holding component 2 is driven toward the mold holding component 4 (in a direction shown by X in FIG. 5 and hereinafter referred to as a pressing direction) by the driving apparatus 7 while the substrate surface is maintained in parallel with the mold surface. As the substrate holding component 2 is moved in the direction X, the rigid part 5a of the retaining component 5 is first brought into contact with the peripheral portion of the mold 3 (step S7) with the interval between the transfer layer 1a on the substrate 1 and the mold 3. As the substrate holding component 2 further approaches the mold holding component 4, the distance between the transfer layer 1a on the substrate 1 and the mold 3 is reduced, the elastic part 5b of the retaining component 5 is contracted and pressure is applied to the contact surface between the retaining component 5 and the mold 3, and the retaining component 5 securely retains the peripheral portion of the mold 3 to fix the position of the peripheral portion of the mold 3 to the mold holding component 4. The retaining component 5 retains the peripheral portion of the mold 3 more securely as the substrate holding component 2 further approaches the mold holding component 4.

Thus, even when the mold 3 is heated or cooled and the temperature changes cause thermal deformation of the mold at a subsequent step, expansion or contraction of the mold 3 can be prevented since the peripheral portion of the mold 3 is mechanically fixed to the mold holding component 4.

As described above, after the mold 3 is heated and the temperature adjustment is finished, the peripheral portion of the mold 3 is fixed and held by the retaining component 5. This can eliminate the influence of the thermal deformation during the heating of the mold 3.

Since the retaining component 5 is in contact with the mold 3 through the surface of the rigid part 5a, the friction between the retaining component 5 and the mold 3 can more tightly fix the peripheral portion of the mold 3 against the force of expansion and contraction of the mold 3.

In addition, the elastic part 5b included in the retaining component 5 enables the pressing of the mold 3 with uniform pressure.

At step S8, as shown in FIG. 5(c), the substrate holding component 2 is further driven in the pressing direction X to reduce the distance between the transfer layer 1a on the substrate 1 and the mold 3 until they are brought into contact. The substrate holding component 2 is further moved in the direction X to press the transfer layer 1a on the substrate against the mold 3 (step S9). The transfer layer 1a on the substrate 1 is being softened resulting from the heating, so that the transfer layer 1a is deformed in accordance with the pattern shape of the mold 3. Since the mold 3 has been heated to the softening point of the transfer layer 1a, the transfer layer 1a is deformed with fluidity maintained in accordance with the pattern shape of the mold 3. The pressure and the holding time period are set in view of the pattern shape of the mold 3 and the material of the transfer layer 1a. The pressure in pressing the mold 3 by the retaining component 5 in FIG. 5(b) may be different from the pressure in pressing and transferring the pattern surface of the mold 3 to the transfer layer 1a on the substrate 1 in FIG. 5(c). It goes without saying that the substrate holding component 2 may be driven in the direction X at constant pressure in FIGS. 5(b) to 5(C). It is possible to stop temporarily the movement of the substrate holding component 2 in the direction X immediately before the pattern surface is pressed and transferred to the transfer layer 1a on the substrate 1 as shown in FIG. 5(c) and to perform a step of automatically determining by the control apparatus 9 based on a detection signal from a sensor, not shown, provided for the imprint apparatus or a step of visually checking by an operator of the imprint apparatus that the mold 3 is fixed reliably at the predetermined position by the retaining component 5.

As the distance between the substrate holding component 2 and the mold holding component 4 is reduced, the elastic part 5b of the retaining component 5 is contracted and the rigid part 5a pressurizes the mold 3 to retain the mold surface more firmly.

Next, at step S10, the heaters 6a and 6b of the substrate holding component 2 and the mold holding component 4, respectively, are turned off to reduce the temperatures of the substrate 1 and the mold 3. In other words, the substrate 1 and the mold 3 are cooled. This reduces the temperature of the transfer layer 1a to the hardening temperature to harden the transfer layer 1a (step S11). The cooling temperature may be adjusted or the gradient of the temperature drop may be adjusted by the temperature adjusting apparatus 6.

The mold 3 is cooled after the heating state and thermally deformed to under go a force to contract toward the inside. The mechanical fixing of the peripheral portion of the mold 3 by the retaining component 5, however, can prevent movement of the mold 3 due to the contraction. This can avoid a displacement of the contact surface between the transfer layer 1a on the substrate 1 and the mold 3 to provide the pattern shape with high accuracy. This leads to elimination of any load caused by a displacement of the substrate 1 from the mold 3, which can prevent damage to the substrate 1 or the mold 3 and also preclude damage to the pattern transferred to the transfer layer 1a.

After the hardening of the transfer layer 1a, at steps S12 to S13, the substrate holding component 2 is moved in a direction away from the mold holding component 4 (corresponding to a direction Y in FIG. 5 and hereinafter referred to as a releasing direction) to release the transfer layer 1a on the substrate 1 from the mold 3 as shown in FIG. 5(d).

At these steps, as the substrate holding component 2 is moved in the direction Y to increase the interval the substrate holding component 2 and the mold 1, the elastic part 5b of the retaining component 5 is expanded in the releasing direction, so that the transfer layer 1a on the substrate 1 is released from the mold 3 while the mold surface is retained by the rigid part 5a of the retaining component 5. Thus, the stress applied to the surface of the transfer layer 1a in the releasing of the transfer layer 1a on the substrate 1 from the mold 3 can be fixed by the contact surface between the retaining component 5 and the mold 3 to reduce the load on the transfer layer 1a to prevent damage to the substrate 1 and the transfer layer 1a.

At steps S13 to S14, as shown in FIG. 5(e), the substrate holding component 2 is further moved in the direction Y to separate the retaining component 5 from the mold 3.

Since the temperature of the mold 3 has been reduced from the heating step (steps S5 to S7) to the cooling state (steps S10 to S11), the mold 3 undergoes a force to contract toward the inside due to thermal contraction. The force to contract toward the inside of the mold 3 produces a reaction force exerted on the mold 3 and the retaining component 5 when the retaining component 5 is separated from the mold 3. However, the retaining component 5 is in contact with the mold 3 through the rigid part 5a, so that the rigid part 3 can reduce the resistance to the mold 3 in the releasing to preclude damage to the components including the mold 3.

According to Embodiment 1 described above, since the peripheral portion of the mold is held by the retaining component from the point in time after the heating of the mold to the pint in time after the releasing of the transfer layer on the substrate from the mold, it is possible to prevent contraction due to thermal deformation of the mold to avoid a displacement of the mold from the transfer layer on the substrate when they are brought into contact, thereby allowing accurate transfer of the pattern shape of the mold to the transfer layer on the substrate.

The present invention is not limited to the abovementioned structure, and appropriate changes can be made in size, shape, or material thereof as long as the pattern formed on the surface of the mold can be pressed against the transfer layer on the substrate while the peripheral portion of the mold is retained. With such a structure, even when the mold is under the influence of thermal deformation due to the temperature changes during the process, the thermal deformation of the mold is avoided by fixing the mold position in the peripheral portion of the mold. As a result, any displacement of the contact surface can be prevented to accurately transfer the pattern. It is also possible to preclude any damage to the components caused by a displacement of the mold and the substrate.

Since the peripheral portion of the mold is retained from the point in time after the temperature adjustment of the mold to the point in time after the releasing of the transfer layer on the substrate from the mold, the peripheral portion of the mold thermally deformed after the temperature adjustment can be retained to avoid distortion of the mold surface. The peripheral portion of the mold is retained to the point in time after the releasing of the transfer layer on the substrate from the mold, so that any displacement of the contact surface between the mold and the transfer layer on the substrate can be eliminated.

Since the mold is fixed and held only at the central position by the mold holding component for holding the mold on the back, the mold is expanded toward the outside from the center during the thermal deformation of the mold. Thus, the peripheral portion of the mold can be retained with distortion of the mold surface prevented favorably.

One surface of the rigid part is opposed to the peripheral portion of the mold and the other surface of the rigid part is pressed through the elastic part to retain the peripheral portion of the mold. This enables the mold to be firmly held by the rigid part and the mold surface to be retained by the elastic part with uniform pressure.

The retaining component according to the present invention is not limited to the abovementioned structure, and it is possible to use any structure that is pressurized by the portion of the substrate holding component outside the substrate holding position to press the peripheral portion of the mold held by the mold holding component. With such a structure, when the distance between the substrate holding component and the mold holding component is reduced for pressing the transfer layer on the substrate against the mold, the retaining component holds the peripheral portion of the mold to allow prevention of thermal deformation of the mold by means of the simple structure.

Since the retaining component includes the rigid part closer to the mold and the elastic part closer to the substrate holding component, the rigid part can securely hold the mold and the elastic part can retain the mold surface with uniform pressure. The thickness of the retaining component is increased and reduced because of the elastic part to enable adjustment of the timing of contact between the retaining component and the mold.

### Embodiment 2

Embodiment 2 will hereinafter be described with reference to FIG. 7. Components identical to those of Embodiment 1 described above are designated with the same reference numerals and description of the same component is omitted.

FIG. 7 is a schematic diagram showing an imprint apparatus according to Embodiment 2 in cross section.

The imprint apparatus shown in FIG. 7 is formed of the structure of the abovementioned imprint apparatus in Embodiment 1 turned upside down. A substrate holding component 2 is fixed with its substrate holding surface facing upward and a mold holding component 4 is driven from above toward and away from the substrate holding component 2 (in a vertical direction in FIG. 7).

With such a structure, the substrate holding surface of the substrate holding component 2 faces upward and a retaining component 5 can be mounted on the substrate holding component 2 from above. This can facilitate the check and adjustment of the position where the retaining component 5 should be mounted.

### Embodiment 3

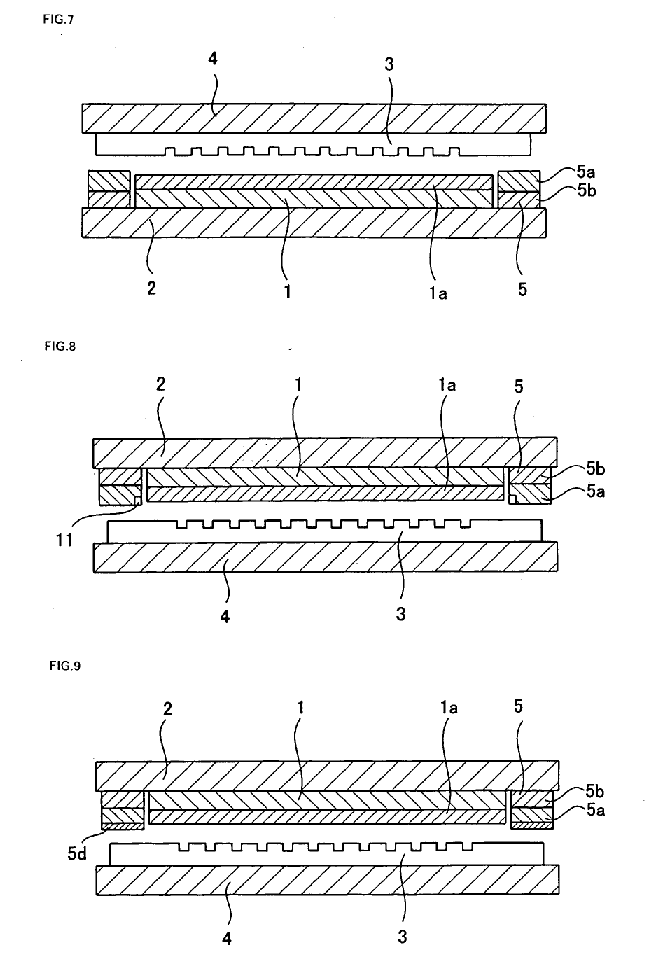

Embodiment 3 of the present invention will hereinafter be described with reference to FIG. 8. Components identical to those of Embodiment 1 described above are designated with the same reference numerals and description of the same component is omitted.

FIG. 8 is a schematic diagram showing an imprint apparatus according to Embodiment 3 in cross section.

A retaining component 5 shown in FIG. 8 includes an air blow mechanism 11 for emitting an air blow at a position on a surface of a rigid part 5a to be brought in contact with a mold 3 that is closer to a substrate holding position of a substrate holding component 2. The air blow mechanism 11 is made of porous material, for example, and serves as a blow-off port. The blow-off port is fed through a pump or the like, not shown, with air, N₂ (nitrogen), or gas provided by mixing ions with the abovementioned gas for reducing adhesion of contaminants due to static electricity in releasing, for example. While a transfer layer 1a on a substrate 1 is in contact with the mold 3, the air blow is discharged toward the contact interface. The air blow mechanism 11 discharges the air blow to the contact interface in the releasing of the transfer layer 1 on the substrate 1 from the mold 3 to perform the releasing step more smoothly and easily.

### Embodiment 4

Embodiment 4 of the present invention will hereinafter be described with reference to FIG. 9. Components identical to those of Embodiment 1 described above are designated with the same reference numerals and description of the same component is omitted.

FIG. 9 is a schematic diagram showing an imprint apparatus according to Embodiment 4 in cross section.

A retaining component 5 shown in FIG. 9 includes an elastic part 5b closer to a substrate holding component 1 and a rigid part 5b closer to a mold 3. A surface of the retaining component 5 to be in contact with the mold 3 is covered with a friction member 5d having a high coefficient of friction with the mold 3. The friction member 5d can be formed of a member having a fine bumpy shape or dimple shape formed on its surface to enhance the frictional force, for example.

Since the friction member 5d in contact with the mold surface can further reduce movement of the mold 3 in a direction perpendicular to the holding direction of the retaining component 5, the mold 3 can be more securely fixed to a mold holding component 4 against expansion and contraction of the mold 3.

The present invention is not limited to the abovementioned structure, and it is possible to use any structure that enhances the frictional force of the contact surface between the mold 3 and the retaining component 5. For example, the frictional force may be increased by performing surface treatment on the rigid part 5a of the retaining component 5 or a frictional surface for enhancing the frictional force may be provided for the mold 3.

### Embodiment 5

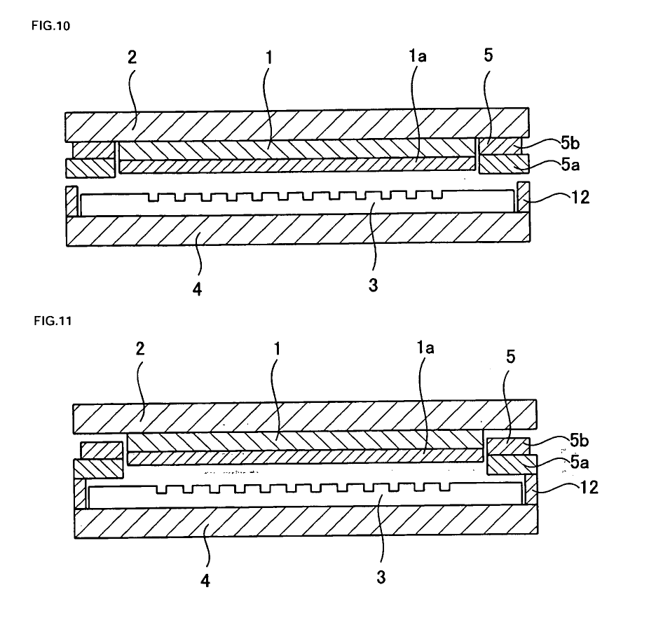

Embodiment 5 of the present invention will hereinafter be described with reference to FIGS. 10 and 11. Components identical to those of Embodiment 1 described above are designated with the same reference numerals and description of the same component is omitted.

FIG. 10 is a schematic diagram showing an imprint apparatus according to Embodiment 5 in cross section.

The imprint apparatus shown in FIG. 10 includes an elastic support member 12 which protrudes from a surface of a mold 3 toward a retaining component 5 and expands and contracts in a pressing direction X at a position opposed to the retaining component 5 mounted on a substrate holding component 2 outside a mold holding position (mold holding area) of a mold holding component 4.

As the substrate holding component 2 is driven in the direction X, the elastic support member 12 first supports a lower surface of the retaining component 5. The elastic support member 12 contracts through the elasticity and continuously supports the lower surface of the retaining component 5 until the retaining component 5 is brought into contact with the mold surface. Thus, the elastic support member 12 absorbs the shock of the contact between the retaining component 5 and the mold 3. When the retaining component 5 retains the mold 3, the elastic support member 12 prevents damage to the mold surface and avoids a displacement of the mold 3.

FIG. 11 shows a modification of Embodiment 5.

An imprint apparatus shown in FIG. 11 includes a retaining component 5 mounted on an elastic support member 12 separately from a substrate holding component 2. As the substrate holding component 2 is driven in the pressing direction X, the substrate holding component 2 is brought into contact with a back side of the retaining component 5 and pressurizes the retaining component 5 in the pressing direction X before contact of a transfer layer 1a on a substrate 1 with a mold 3. As the substrate holding component 2 is further moved in the direction X, a rigid part 5a of the retaining component 5 is brought into contact with the mold 3 to pressurize the mold 3 to fix the position of the peripheral portion of the mold 3 to a mold holding component 4. Then, the transfer layer 1a on the substrate 1 is brought into contact with the mold 3 and is pressurized to replicate the pattern of the mold 3 to the transfer layer 1a on the substrate 1.

With such a structure, the operation of mounting the retaining component 5 on the substrate holding component 2 can be omitted. For example, the retaining component 5 and the elastic support member 12 may be assembled and the assembled elastic support member 12 may be placed on the mold holding component 4.

As described above, in the imprint method of the present invention, the mold having the pattern formed on the surface is pressed against the transfer layer on the substrate to replicate the pattern shape of the mold to the transfer layer. While the peripheral portion of the surface of the mold is held by the retaining component pressurized by the substrate holding component for holding the substrate, the mold is pressed against the transfer layer on the substrate. This can prevent any displacement of the pattern shape due to thermal deformation of the mold to accurately replicate the pattern shape to the transfer layer on the substrate.

In the imprint apparatus according to the present invention, the mold having the pattern formed on the surface is pressed against the transfer layer on the substrate to replicate the pattern shape of the mold to the transfer layer. The imprint apparatus includes the substrate holding component which holds the substrate, the mold holding component which holds the mold, and the retaining component which is pressurized by the portion of the substrate holding component outside the substrate holding position to retain the peripheral portion of the surface of the mold. This can prevent any displacement of the pattern shape due to thermal deformation of the mold to accurately replicate the pattern shape to the transfer layer on the substrate.

Finally, manufacturing of a magnetic disk with the imprint apparatus shown in FIG. 1 will be described with reference to FIGS. 12 to 15.

FIG. 12 shows an example of the pattern shape formed on the mold 3 for manufacturing magnetic disks. As shown in FIG. 12, bumps corresponding to a patterned data track portion 31 and a servo pattern portion 32 are formed on the surface of the mold 3 having the pattern formed thereon. Particularly, the pattern corresponding to the patterned data track portion 31 is a fine one formed over the entire surface at regular intervals and having a size of approximately 25 nm. In recent years, magnetic disks with increasingly larger capacities advantageously have an extremely fine pattern formed thereon corresponding to a very high surface recording density of 500 Gbpsi (Gbit/inch²) or higher, and more specifically, approximately 1 to 10 Tbpsi. The use of a mold having a pattern with a bit interval of an approximately 25 nm formed thereon enables fabrication of a recording medium having a high-density pattern with a recording density of approximately 1 Tbpsi. The extremely fine pattern is desirably formed through electron beam writing capable of forming a high-resolution pattern.

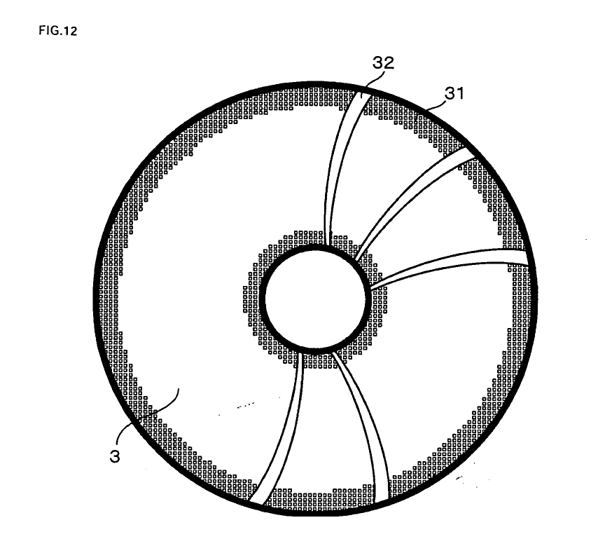

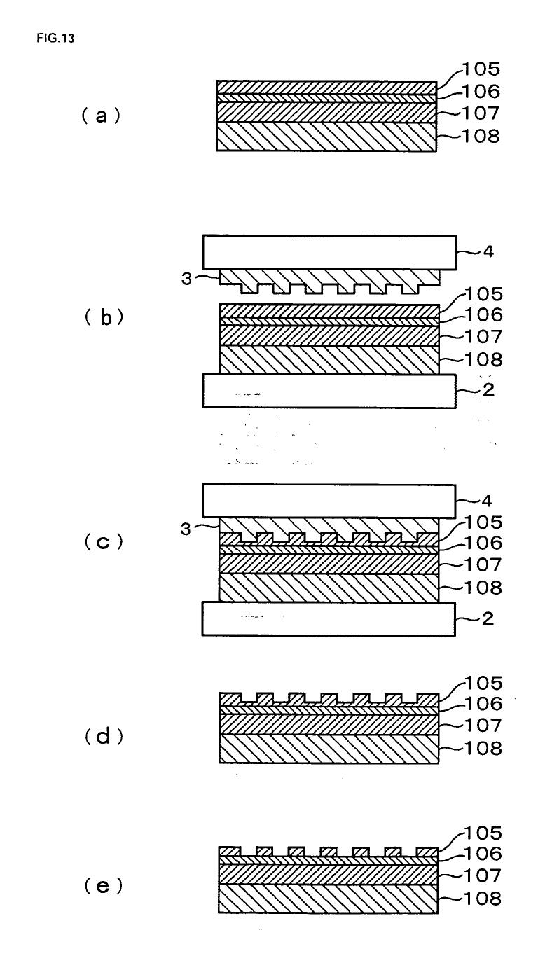

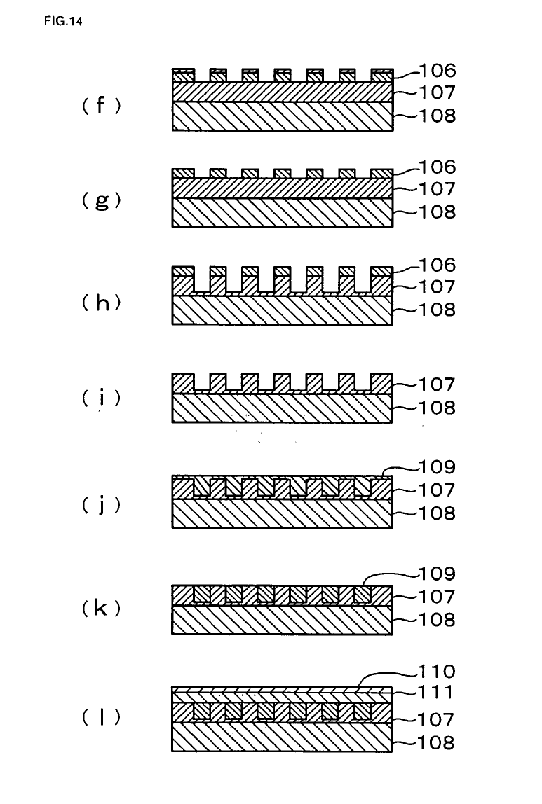

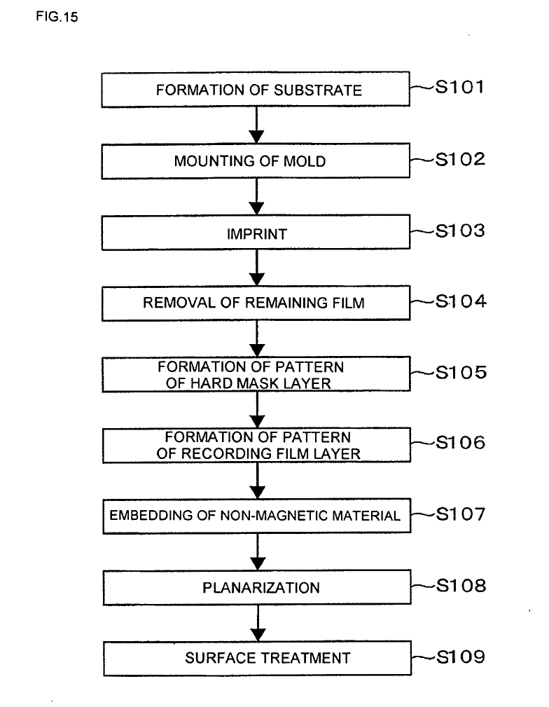

Next, steps for manufacturing a magnetic disk will be described with reference to FIGS. 13 to 15. FIGS. 13 and 14 schematically show respective steps. FIG. 15 shows a flow chart of the steps.

First, at step S101, as shown in FIG. 13(a), a base substrate 108 for a recording medium is prepared which is made of specially processed, chemically strengthened glass, Si wafer, aluminum plate, or other material (preparation of the base substrate 108). Then, a recording film layer 107 is deposited on the base substrate 108 through sputtering or the like (formation of the recording film layer 107). For a vertical magnetic recording medium, a stack of a soft magnetic underlayer, an intermediate layer, a ferromagnetic recording layer and the like is provided. Then, a hard mask layer (metal mask layer) 106 made of Ta, Ti or the like is formed on the recording film layer 107 through sputtering or the like (formation of the hardmask layer 106). Thermoplastic resin such as polymethylmethacrylate (PMMA) is applied as a transfer material onto the hard mask layer 106 through spin coating or the like (formation of the transfer layer 105).

At step S102, as shown in FIG. 13(b), the mold 3 facing downward is mounted on the mold holding component 4 such that its surface having the pattern formed thereon is opposed to the transfer layer 105 of the substrate placed on the surface of the substrate holding component 2 (mounting of the mold). At this point, the horizontal position adjustment of the mold holding component 4 and the substrate holding component 2 is performed.

At step S103, an imprint step is performed in accordance with the flow chart shown in FIG. 6. Specifically, the pressure in the apparatus is reduced as required, and the mold 3 and the substrate are heated to the temperature at which the transfer layer 105 has fluidity, and then the peripheral portion of the mold 3 is held by the retaining component 5 (not shown), and in this state, the mold 3 is pressed against the transfer layer 105 (FIG. 13(c)). For example, when polymethylmethacrylate (PMMA) is used, its glass transition temperature is approximately 100° C. and thus the mold 3 and the substrate are heated to a temperature higher than the glass transition temperature in a range of 120 to 200° C. (for example, approximately 160° C.). Then, the mold 3 is pressed against the transfer layer 105 with a pressing force of 1 to 10000 kPa (for example, approximately 1000 kPa). Since gas is produced at this point from moisture contained in the solvent or resin remaining after the application of the transfer layer 105, the imprint apparatus is desirably evacuated to a vacuum of several hundreds of Pa (for example, approximately 10 Pa). Next, the transfer layer 105 is cooled through temperature adjustment to harden the resin, the atmosphere in the apparatus is restored, and the mold 3 is released from the transfer layer 105. The pattern is transferred to the transfer layer 105 in this manner (FIG. 13(d)).

At step S104, the substrate removed from the imprint apparatus is subjected to soft ashing with O₂ gas or the like to remove the remaining film of the transfer layer 105 (removal of the remaining film layer).

The resulting remaining pattern of the transfer layer 105 will serve as an etching mask for etching the hard mask layer 106 (FIG. 13(e)).

At step S105, as shown in FIG. 13(f), the hard mask layer 106 is etched with CHF₃ gas or the like to form the pattern of the hard mask layer 106. Then, as shown in FIG. 13(g), the remaining etching mask (transfer layer 105) is removed through wet process, ashing or the like (formation of the pattern of the hard mask layer).

At step S106, as shown in FIG. 13(h), the hard mask layer 106 formed into the pattern is used as the etching mask to perform dry etching with Ar gas or the like to form the pattern of the recording film layer 107 (formation of the pattern of the recording film layer 107). Then, as shown in FIG. 13(i), the remaining hard mask layer 106 is removed through wet process, dry etching or the like.

At step S107, as shown in FIG. 13(j), a non-magnetic material 109 (non-magnetic material such as SiO₂ for the magnetic recording medium) is embedded in the concaves in the recording film layer 107 through sputtering or application (embedding of the non-magnetic material 109).

At step S108, as shown in FIG. 13(k), the surface is polished to perform planarization through etching, chemical polishing or the like (planarization). This results in the structure in which the recording material is sectioned by the non-recording material 109.

At step S109, as shown in FIG. 13(l), a surface protecting layer 111 made of carbon or the like is formed through CVD or sputtering, and a lubricating layer 110 is formed through dipping or the like (surface treatment).

The magnetic disk having the fine pattern structure is manufactured in this manner. Finally, the magnetic disk is incorporated into a hard disk drive which includes a driving system for a magnetic disk medium (such as a spindle motor and a rotation driving control circuit) and a read/write mechanism for magnetic information (such as a magnetic head, a suspension, and an error correction circuit) to finish a magnetic recording apparatus.

In the imprint method and the imprint apparatus according to the present invention, the peripheral portion of the mold 3 heated to the predetermined temperature is held by the retaining component 5, and in this state, the surface of the mold 3 having the pattern formed thereon is pressed against the transfer layer 105 and the resin is hardened through cooling. Thermal expansion and contraction of the mold 3 due to the process temperature changes can be prevented to replicate the pattern with high accuracy even in the replicate of the fine pattern of approximately 25 nm shown exemplarily in FIG. 12.

While some specific embodiments of the present invention have been described, it is apparent to those skilled in the art that various modifications can be made without departing from the spirit and scope of the present invention. Therefore, the technical scope of the present invention is not limited to the abovementioned embodiments but should be defined on the basis of the appended claims and the equivalents thereof.

1-18. (canceled)

19. An imprint method for pressing a mold having a pattern formed on a surface thereof against a transfer layer on a substrate to replicate the shape of the pattern of the mold to the transfer layer, comprising:
forming a state in which a peripheral portion of the surface of the mold fixed at a central portion thereof by a mold holding component is held by a retaining component pressurized by a substrate holding component which holds the substrate for a time period from a point in time after the mold is adjusted to a predetermined temperature to a point in time after the mold is pressed against the transfer layer on the substrate and then released from the transfer layer, and in this state, pressing the mold against the transfer layer on the substrate.

20. The imprint method according to claim 19, wherein the peripheral portion over the entire perimeter of the surface of the mold is held by the retaining component.

21. The imprint method according to claim 19, wherein the peripheral portion of the surface of the mold is pressed against the mold holding component which holds the mold.

22. The imprint method according to claims 19, wherein the peripheral portion of the surface of the mold is opposed to a rigid part, and the rigid part is pressed from a back side thereof through an elastic part to hold the peripheral portion of the surface of the mold.

23. An imprint method for pressing a mold having a pattern formed on a surface thereof against a transfer layer on a substrate to replicate the shape of the pattern of the mold to the transfer layer, comprising:
pressing the mold against the transfer layer on the substrate in a state in which a peripheral portion of the surface of the mold is held by a retaining component pressurized by a substrate holding component which holds the substrate, the retaining component being provided with an air blow mechanism which blows a gas to a contact interface between the surface of the mold having the pattern formed thereon and the transfer layer on the substrate.

24. The imprint method according to claim 19, wherein the peripheral portion of the surface of the mold is held by a surface of the retaining component, the surface being covered with a friction member.

25. An imprint method for pressing a mold having a pattern formed on a surface thereof against a transfer layer on a substrate to replicate the shape of the pattern of the mold to the transfer layer, comprising:
opposing the peripheral portion of the surface of the mold to a retaining component, interposing an elastic support member between the retaining component and a mold holding component which holds the mold, bringing the retaining component into contact with the surface of the mold while a reaction force from elasticity of the elastic support member is exerted on the retaining component, and pressing the mold against the transfer layer on the substrate in a state in which the peripheral portion of the surface of the mold is held by the retaining component pressurized by a substrate holding component which holds the substrate.

26. An imprint apparatus for pressing a mold having a pattern formed on a surface thereof against a transfer layer on a substrate to replicate the shape of the pattern of the mold to the transfer layer, comprising:
a substrate holding component which holds the substrate;
a mold holding component which holds the mold by fixing a central portion of the mold; and
a retaining component which is pressurized by a portion of the substrate holding component outside a substrate holding position to retain a peripheral portion of the surface of the mold for a time period from a point in time after the mold is adjusted to a predetermined temperature to a point in time after the mold is pressed against the transfer layer on the substrate and then released from the transfer layer.

27. The imprint apparatus according to claim 26, wherein the retaining component has a surface for holding the peripheral portion over the entire perimeter of the surface of the mold.

28. The imprint apparatus according to claim 26, wherein the retaining component presses the peripheral portion of the surface of the mold against the mold holding component.

29. The imprint apparatus according to claim 26, wherein the retaining component includes a rigid part closer to the surface of the mold and an elastic part closer to the substrate holding component.

30. An imprint apparatus for pressing a mold having a pattern formed on a surface thereof against a transfer layer on a substrate to replicate the shape of the pattern of the mold to the transfer layer, comprising:
a substrate holding component which holds the substrate;
a mold holding component which holds the mold; and
a retaining component which is pressurized by a portion of the substrate holding component outside a substrate holding position to retain a peripheral portion of the surface of the mold,
wherein the retaining component is provided with an air blow mechanism which blows a gas to a contact interface between the surface of the mold having the pattern formed thereon and the transfer layer on the substrate.

31. The imprint apparatus according to claims 26, wherein the retaining component includes a surface in contact with the surface of the mold, the surface being covered with a friction member.

32. An imprint apparatus for pressing a mold having a pattern formed on a surface thereof against a transfer layer on a substrate to replicate the shape of the pattern of the mold to the transfer layer, comprising:
a substrate holding component which holds the substrate;
a mold holding component which holds the mold;
a retaining component which is pressurized by a portion of the substrate holding component outside a substrate holding position to retain a peripheral portion of the surface of the mold; and
an elastic support member placed outside a mold holding area of the mold holding component, and while the elastic support member applies a reaction force from elasticity to the retaining component approaching the peripheral portion of the mold, the retaining component is brought into contact with the mold.

33. The imprint method according to claim 20, wherein the peripheral portion of the surface of the mold is pressed against the mold holding component which holds the mold.
